(19) United States
(12) Patent Application Publication
(10) Pub. No.: US 2009/0037530 A1
(43) Pub. Date: Feb. 5, 2009

(54) Media broadcasting system

(76) Inventor: Christopher Lee Bennetts, Hsin Tien City (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,360

(22) Filed: Jul. 31, 2007

(51) Int. Cl. G06F 15/16

(52) U.S. Cl. 709/204

(57) ABSTRACT

A media broadcasting system, comprising an electronic device having a communication module interface executable to cause a display of a media output window for displaying media content for a simulcast event, the media output window configured to display a recipient list thereon to enable selection of at least one recipient to participate in the simulcast event

### BACKGROUND

Media broadcasting systems enable participants at different locations to view simulcasted media content. Such broadcasting systems are utilized to transmit and display simulcasted media content; however, such media broadcasting systems are difficult to navigate (e.g., difficult to view participants and/or other media content) thereby increasing the complexity of the video conference sessions.

### BRIEF DESCRIPTION OF THE DRAWINGS

FIG. 1 is diagram illustrating an embodiment of a media broadcasting system 10;

FIG. 2 is a block diagram illustrating an embodiment of an electronic device of the media broadcasting system of FIG. 1;

FIG. 3 is a diagram illustrating an embodiment of a media output window of a user interface at the electronic device of FIG. 2;

FIG. 4 is a diagram illustrating the menu system of FIG. 3;

FIG. 5 is a diagram illustrating media output window of FIG. 3;

FIG. 6 is a diagram illustrating another embodiment of media output window of FIG. 3; and

FIGS. 7 and 8 are diagrams illustrating a display screen of a recipient's electronic device upon receiving an invitation from the simulcasting electronic device.

### DETAILED DESCRIPTION OF THE DRAWINGS

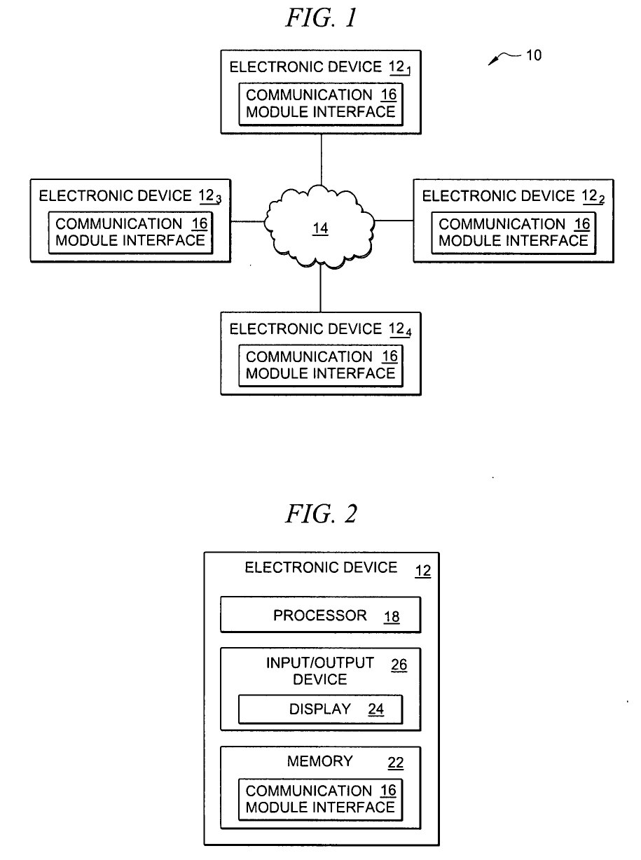

Various embodiments and the advantages thereof are best understood by referring to FIGS. 1-8, like numerals being used for like and corresponding parts of the various drawings

FIG. 1 is diagram illustrating an embodiment of a media broadcasting system 10 to facilitate the simulcasting of media content. In the embodiment illustrated in FIG. 1, system 10 comprises a plurality of electronic devices 12₁, 12₂, 12₃ and 12₄. Electronic devices 12₁, 12₂, 12₃ and or 12₄ may comprise any type of electronic device such as, but not limited to, a notebook or laptop computer, a desktop computer, a karaoke device, or any other type of portable or non-portable electronic device. In the embodiment illustrated in FIG. 1, four electronic devices 12₁, 12₂, 12₃ and 12₄ are illustrated; however, it should be understood that a greater or fewer number of electronic devices 12₁, 12₂, 12₃ and/or 12₄ may be used in connection with system 10. According to some embodiments, communications network 14 comprises a local area network; however, it should be understood that communications network 14 may be any type of wired and/or wireless communications network (e.g., the Internet, a cellular network, etc.) that enables video communications between electronic devices 12₁, 12₂, 12₃ and 12₄.

In the embodiment illustrated in FIG. 1, each electronic device 12₁, 12₂, 12₃ and/or 12₄ comprises a communication module interface 16 to facilitate simulcasting and/or other communications among electronic devices 12₁, 12₂, 12₃ and 12₄. For example, according to some embodiments, electronic devices 12₁, 12₂, 12₃ and 12₄ are configured to simulcast media content (e.g., a live video feed and/or a video message) via communications network 14 to other electronic devices 12₁, 12₂, 12₃ and/or 12₄. According to some embodiments, each electronic device 12₁, 12₂, 12₃ and/or 12₄ is configured to receive media content from other electronic devices 12₁, 12₂, 12₃ and/or 12₄ to enable each user to communicate with other users at their respective electronic devices 12₁, 12₂, 12₃ and/or 12₄. Accordingly, users of system 10 can participate in media communications at separate terminals (e.g., a separate electronic device 12₁, 12₂, 12₃ and/or 12₄).

FIG. 2 is a block diagram illustrating an embodiment of an electronic device 12 of media broadcasting system 10 of FIG. 1. In the embodiment illustrated in FIG. 2, electronic device 12 comprises a processor 18, an input/output device 20 in the form a of a display screen 24 and a memory 22. In FIG. 2, user interface 20 comprises a display screen 24 for displaying media content, such as, but not limited to, video images in a video conference, video messages, or any other type of media content. In FIG. 2, memory 22 comprises communication module interface 16. Communications module interface 16 may comprise hardware, software, firmware or a combination thereof. In FIG. 2, communications module interface 16 is illustrated as being stored in memory 22 to be accessible and/or executable by processor 18. However, it should be understood that communication module interface 16 may be otherwise stored or located, even remotely. In operation, communication module interface 16 is configured to enable media simulcasts between users of electronic devices 12₁, 12₂, 12₃ and/or 12₄.

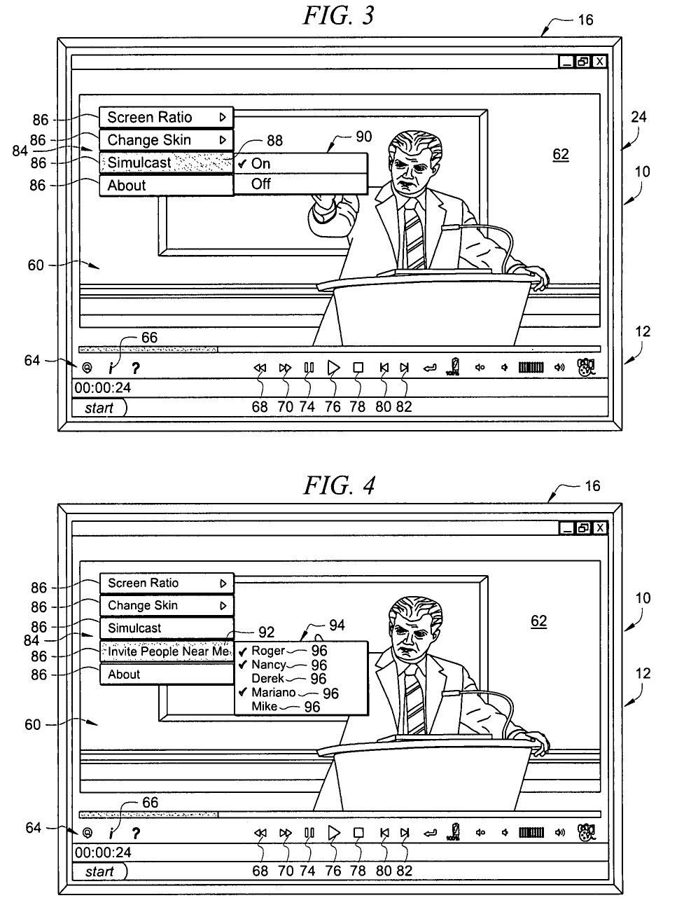

FIG. 3 is a diagram illustrating an embodiment of a media output window 60 of communications module interface 16. In the embodiment illustrated in FIG. 3, communications module interface 16 (FIGS. 1 and 2) is executable to display media output window 60 on display screen 24. In FIG. 3, media output window 60 comprises a video display panel 62 and a command panel bar 64. In the embodiment illustrated in FIG. 3, video display panel 62 is configured to display media content, and command panel 62 is configured to provide status information to a user of electronic device 12 and to enable a user to provide commands to communication module interface 16 (FIGS. 2). For example, in the embodiment illustrated in FIG. 3, media content may comprise a live video feed from a webcam and/or a file stored on an electronic device 12 (electronic device 12 represents one or more of electronic devices 12₁, 12₂, 12₃ and/or 12₄) and displayable on display panel 62. Communications panel 64 comprises various types of interfaces for receiving input commands such as, but not limited to, a menu display button 66, a rewind button 70, a forward button 72, a pause button 74, a play button 76, a stop button 78, a skip back button 80, a skip forward button 82 or any other function to facilitate the viewing of media content displayed within output window 60. Command panel 62 is configured to be displayed on both transmitting and receiving participants.

In the embodiment illustrated in FIG. 3, media broadcasting system 10 comprises a pop-up menu system 84 to facilitate a simulcasting event (e.g., the simulcast of media content from one electronic device 12 for viewing on one or more other electronic devices 12 via communications network 14). For example, if a user of electronic device 12 (e.g., electronic device 12₁) desires to simulcast a live video feed or stored file from the user's electronic device 12, the user invokes pop-up menu system 84 to facilitate the simulcast event to other participants (e.g., electronic device 12₂, 12₃ and/or 12₄). In the embodiment illustrated in FIG. 3, menu system 84 is hidden from view until it is invoked by a user of the simulcasting electronic device 12. For example, in the embodiment illustrated in FIG. 3, interface 30 causes pop-up menu system 84 to display a plurality of menu options 86 to facilitate the input of commands to communications module interface 16. For example, in the embodiment illustrated in FIG. 3, menu options 86 comprise a simulcast command 88 to enable communications module interface 16 (FIG. 2) to simulcast media content to other participants (e.g., users of electronic devices 12₁, 12₂, 12₃ and/or 12₄). While four menu options 86 are displayed on menu system 84, it should be understood that a greater or fewer number of menu options 86 may be displayed on menu system 84.

According to some embodiments, interface 16 causes menu system 84 to be displayed in response to a user pressing and/or otherwise activating menu display button 66 on output window 60; however, it should be understood that other methods of invoking menu system 84 are available (e.g., via remote control, via a stylus, by right clicking a mouse when the cursor is over any portion of window 60, etc.). Once menu system 84 has been invoked, menu system 84 is navigatable to enable a user to select simulcast command 88 to turn on/off the simulcast option (e.g., to enable and/or disable communication module interface 16). In operation, a user of electronic device 12 selects simulcast command 88 via mouse, remote control, stylus, keyboard or otherwise such that once selected, interface 16 causes a sub-menu 90 to display an “on” option 92 and an “off” option 94 to enable a user of electronic device 12 to turn on or off and/or otherwise configure communication module interface 16 for simulcasting.

FIG. 4 is a diagram illustrating menu system 84 of FIG. 3. In operation, when simulcast option 88 is turned on, interface 16 causes menu system 84 to display an “invite people near me” option 92 to enable the user of electronic device 12 to view a recipient list 94. In the embodiment illustrated in FIG. 4, recipient list 94 displays all recipients communicatively coupled to system 10 via communication network 14 to enable a user of electronic device 12 to select desired recipient(s) 96 for a particular simulcast event. According to some embodiments, interface 16 causes menu system 84 to be removed from media output window 60 in response to selecting menu display button 66. However, it should be understood that communication module interface 16 may be otherwise configured such that interface 16 causes menu system 84 to be automatically removed after a predetermined period of time of no activity (e.g., no use of pop-up menu system 84). In operation, a user of electronic device 12 selects recipients 96 via a mouse, remote control, stylus or otherwise. Once selected, communications module interface 16 sends an invite command to each electronic device 12 corresponding to the respective selected recipient 96 to participate in the simulcast event. In the embodiment illustrated in FIG. 4, three recipients 96 are selected (e.g., Roger, Nancy and Mariano); however, it should be understood that a greater or fewer number of recipients 96 may be selected based on the number of electronic devices 12 coupled via network 14.

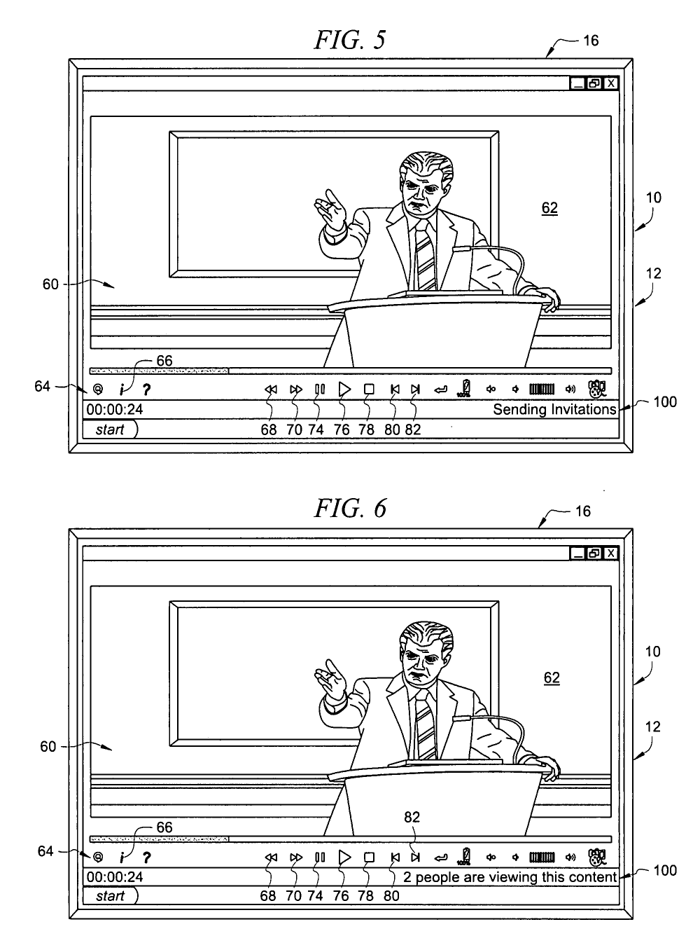

FIGS. 5 and 6 are diagrams illustrating another view of media output window 60 of FIG. 3. In the embodiment illustrated in FIG. 5, media output window 60 comprises a status indicator 100 to provide the user of electronic device 12 a current status of system 10 or of the simulcast event. For example, in the embodiment illustrated in FIG. 5, status bar 100 comprises a notification to the user of electronic device 12 that communications module 16 is sending invitations to each selected recipient 96.

In the embodiment illustrated in FIG. 6, once one or more recipients view media content from electronic device 12, communication module interface 16 causes status indicator 100 to notify the user of electronic device 12 the number of recipients 96 viewing the content. According to some embodiments, status indicator 100 may be configured to, once selected by a user of electronic device 12, list and/or otherwise identify each recipient viewing, streaming and/or downloading the media content via communications network 14.

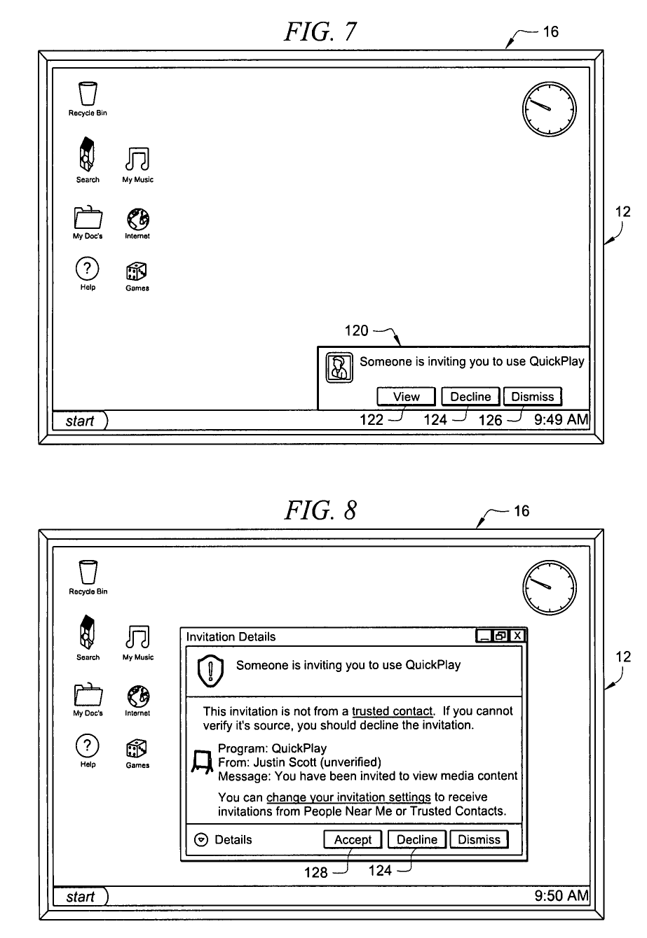

FIGS. 7 and 8 are diagrams illustrating a display screen 24 of a recipient's electronic device 12 upon receiving an invitation from the simulcasting electronic device 12. In the embodiment illustrated in FIG. 7, interface 16 generates a simulcast notification 120 to alert the user of electronic device 12 that they have been invited to participate in a simulcast event. In the embodiment illustrated in FIG. 7, in response to receiving an invitation from the simulcasting device 12, communication module interface 16 causes simulcast notification 120 to appear on display screen 24 to alert the user of electronic device 12. In the embodiment illustrated in FIGS. 7 and 8, notification 120 comprises a view option 122, a decline option 124 and a dismiss option 126. In FIG. 7, in response to selecting view option 122, the details of notification 120 are displayed on display screen 24, as illustrated in FIG. 8. For example, in the embodiment illustrated in FIG. 8, notification 120 is configured to identify the simulcasting party and provide an accept option 128 to enable the recipient to accept the invitation from the simulcasting party. In response to selecting accept option 128, media communication interface 16 of each recipient electronic device 12 will automatically display media output window 60 (FIGS. 3-6) on display screen 24.

According to some embodiments, in response to selecting decline option 124, notification 120 is removed from display screen 24 and a decline notification is sent to the simulcasting party (e.g., electronic device 12₁) indicating that the recipient (e.g., a user of electronic device 12₂, 12₃, and/or 12₄) declined to accept the simulcast invitation. Dismiss option 126 enables the user to decline the invitation without sending a decline notification to the simulcasting party (e.g., electronic device 12₁)

Thus, embodiments of communication module interface 16 enable a simulcasting party and recipient to easily navigate to transmit and/or view media content during a video simulcast. Furthermore, embodiments may be implemented in software and can be adapted to run on different platforms and operating systems. In particular, functions implemented by interface 16, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a computer-readable medium can be any means that can contain, store, communicate, propagate or transport the program for use by or in connection with the instruction execution system, apparatus or device. The computer-readable medium can be, for example but is not limited to, an electronic, magnetic, optical, electro-magnetic, infrared, or semiconductor system, apparatus, device or propagation medium.

What is claimed is:

1. A media broadcasting system, comprising:
an electronic device having a communication module interface executable to cause a display of a media output window for displaying media content for a simulcast event, the media output window configured to display a recipient list thereon to enable selection of at least one recipient to participate in the simulcast event.

2. The system of claim 1, wherein the communication module interface is configured to display a status notification to display a status of the simulcast event.

3. The system of claim 1, wherein the communication module interface is executable to cause the display of a notification indicating a transmission of at least one invitation to the at least one recipient.

4. The system of claim 1, wherein the communication module interface is configured to display a notification indicating a number of recipients viewing the media content.

5. The system of claim 1, wherein the communication module interface is configured to display a video display panel and a command panel in the media output window.

6. A media broadcasting system, comprising:
an electronic means having a communication module interface means executable to cause a display of a media output means for displaying media content for a simulcast event, the media output means configured to display a means for listing recipients thereon to enable selection of at least one recipient to participate in the simulcast event.

7. The system of claim 6, wherein the communication module interface means is configured to display of a notification means associated with the simulcast event.

8. The system of claim 6, wherein the communication module interface means is configured to display of a notification means indicating a transmission of at least one invitation means to the at least one recipient.

9. The system of claim 6, wherein the communication module interface mans is executable to cause the display of a notification means indicating the number of recipients viewing the media content.

10. The system of claim 6, wherein the communication module interface means is executable to cause the display of recipient listing means.

11. A media broadcasting method, comprising:
displaying a media output window for displaying media content for a simulcast event, the media output window configured to display a recipient list thereon to enable selection of at least one recipient to participate in the simulcast event.

12. The method of claim 11, further comprising displaying a notification associated with the simulcast event.

13. The method of claim 11, further comprising displaying a status notification in the media output window indicating a transmission of at least one invitation to the at least one recipient.

14. The method of claim 11, further comprising displaying a status notification in the media output window indicating a number of recipients viewing the media content.

15. The method of claim 11, further comprising displaying a video display panel and a command panel in the media output window.
